(19) United States
(12) Patent Application Publication
(10) Pub. No.: US 2013/0337312 A1
(43) Pub. Date: Dec. 19, 2013

(54) SEPARATOR FOR ELECTROCHEMICAL DEVICES AND METHOD OF MANUFACTURING THE SEPARATOR

(71) Applicants: Jong Hyeok Park, Suwon-si (KR); Min Kim, Seoul (KR)

(72) Inventors: Jong Hyeok Park, Suwon-si (KR); Min Kim, Seoul (KR)

(73) Assignee: RESEARCH & BUSINESS FOUNDATION SUNGKYUNKWAN UNIVERSITY, Suwon-si (KR)

(21) Appl. No.: 13/879,511

(22) PCT Filed: Oct. 17, 2011
(86) PCT No.: PCT/KR11/07713

§ 371 Date: Sep. 5, 2013

(30) Foreign Application Priority Data
Oct. 15, 2010 (KR) 10-2010-0100994

(51) Int. Cl. H01M 2/16

(52) U.S. Cl. CPC H01M 2/1686
USPC 429/145; 429/144; 427/126.3

(57) ABSTRACT

There are provided a separator for electrochemical devices and a method of manufacturing the separator, and more particularly, a thin film separator for electrochemical devices which is improved in thermal stability and can be high-density charged for high capacity by employing a coating layer formed of an inorganic oxide thin film directly on a porous substrate and a method of manufacturing the separator using a film deposition method.

### CROSS-REFERENCE TO RELATED APPLICATION

This application is a continuation of International Patent Application No. PCT/KR2011/007713, filed on Oct. 17, 2011, which claims priority to and the benefit of Korean Patent Application No. 10-2010-0100994, filed on Oct. 15, 2010, the disclosure of which is incorporated herein by reference in its entirety.

### BACKGROUND

1. Field of the Invention

The present invention relates to a separator for electrochemical devices and a method of manufacturing the separator.

2. Discussion of Related Art

Entering the 21st century, the IT industry has continued to develop more rapidly than other fields of science and technology. Such development has been made mainly in easily portable mobile devices such as notebooks, mobile phones, and the like. Recently, along with functional diversification of mobile devices and booming development of eco-friendly car batteries, electrochemical devices thereof have attracted increasing attention as energy sources. Particularly, development of chargeable and dischargeable secondary batteries as one of the electrochemical devices is the focus of attention. Recently, development of the electrochemical devices has progressed into research and development of design for new electrodes and batteries to satisfy demands for miniaturization, weight lightening, mass storage capability, and high stability.

Among currently commercialized secondary batteries, lithium ion secondary batteries developed in 1991 require higher operation voltage and have higher capacity and higher power than Pd-acid, Ni—Cd, and Ni-MH batteries, and thus have steadily attracted attention. The lithium ion secondary batteries can be classified roughly into lithium ion batteries and lithium polymer batteries depending on a kind of an adopted separator/electrolyte. The lithium ion batteries use a liquid organic electrolyte to which a lithium salt is added, resulting in acceleration in battery assembly and improvement in ionic conductivity at room temperature. However, mechanical properties thereof are somewhat weakened and stability problems such as corrosion of electrodes and ignition/explosion may occur. Such problems can be solved with the recent lithium polymer batteries which can be manufactured to be thin with high stability using a polymer electrolyte. Further, the lithium polymer batteries have been considered as next generation batteries which can be manufactured with various sizes and various designs. However, the polymer electrolyte used in the lithium polymer battery has relatively lower ionic conductivity than the liquid electrolyte used in the lithium ion battery, and thus the lithium polymer battery has high inner resistance and is not appropriate for high current discharge and its discharge property is rapidly decreased at a low temperature. Therefore, improvement on these matters is urgently needed.

Although the above-described electrochemical devices have been produced by many manufacturing companies, respective devices have their own safety properties. Recently, because a potential risk of safety accidents such as ignition and explosion accidents of electrochemical devices has sharply increased, safety evaluation and safety assurance of electrochemical devices have become an important issue. Globally, not only a demand for safety check on a national level but also a demand for consumer-oriented safety check have increased, and thus regulations of compulsory certification have been carried out and expanded by respective governments and technologies have been standardized. Such electrochemical devices may malfunction depending on operation conditions, and thus thermal runaway may occur due to overheating during malfunction, or a separator may be decomposed, resulting in an explosion. In particular, a polyolefin-based porous substrate which is currently and typically used as a separator of an electrochemical device shows severe thermal contraction at a temperature of 100° C. or more due to its material property of typically melting at a temperature of 200° C. or less and a characteristic of an elongation process of adjusting a pore size and a porosity, resulting in an internal short circuit.

In order to solve the above-described safety problems of electrochemical devices, Korean Patent Laid-open Publication Nos. 2006-0072065 and 2007-0000231 suggest a separator in which a porous coating layer made of a mixture of inorganic filler particles and a polymer binder is formed on one or both surfaces of a porous substrate. The inorganic filler particles of the microporous coating layer formed on the porous substrate serve as a kind of passivation capable of maintaining a physical form. Thus, it is possible to suppress thermal contraction of the porous substrate caused by overheating during malfunction of an electrochemical device and also possible to form micropores at empty spaces between the polymer binder and the inorganic filler particles. As stated above, the microporous coating layer formed on the porous substrate contributes to improvement in safety of electrochemical devices. Conventionally, particles of BaTiO₃, Pb(Zr,Ti)O₃ (PZT), ZrO₃, SiO₂, Al₂O₃, TiO₂, Li₃PO₄, and LiₓTi_{y}(PO₄)₃ (0<x<2, 0<y<3) have been used as the inorganic filler particles used for forming the microporous coating layer. However, there is an internal problem in that a small amount of polymer binder mixed with such materials can be melted or deformed at a high temperature, and also there is a problem in that a coating layer made of such materials may have a thickness in micrometers and does not satisfy a property of a thin separator which can be high-density charged for high capacity. Further, a patent application related to a separator coated with particles to a thickness of about 5 μm on felt including pores ranging from 75 μm to 150 μm by means of a sol-gel method has been filed (Degussa, Korean Patent Application No. 2005-7003099). However, since inorganic nanoparticles are used, it is difficult to control pores and the separator has low tensile strength as compared with conventional polymer separators.

### SUMMARY OF THE INVENTION

In order to solve the above-described problems, the present inventors accomplished the present invention by developing a separator for electrochemical devices. The separator is improved in thermal stability and can be high-density charged for high capacity by employing a coating layer formed of an inorganic oxide thin film on a porous substrate by means of deposition.

Therefore, objects of the present invention are to provide a separator for electrochemical devices including a porous substrate and a coating layer of a thin film coating the porous substrate with an inorganic oxide, a method of manufacturing the separator, and a use thereof.

In order to achieve the above objects, according to a first aspect of the present invention, there is provided a separator for electrochemical devices including a porous substrate, and a thin film coating layer prepared by coating an inorganic oxide on the porous substrate.

According to a second aspect of the present invention, there is provided a method of manufacturing a separator for electrochemical devices including manufacturing a thin-film coating layer prepared by coating an inorganic oxide through film-deposition of an inorganic precursor on the porous substrate.

According to a third aspect of the present invention, there is provided an electrochemical device including the separator according to the first aspect.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic cross-sectional view of a separator including a coating layer formed of an inorganic oxide thin film by means of chemical vapor deposition according to an exemplary embodiment of the present invention;

FIG. 2 is a scanning electron microscopy image of a separator including a coating layer formed of an inorganic oxide thin film according to an exemplary embodiment of the present invention; and

FIG. 3 is a graph measuring charge/discharge operations of a battery including a separator according to an exemplary embodiment of the present invention [red line: discharge, black line: charge].

### DETAILED DESCRIPTION OF EXEMPLARY EMBODIMENTS

Hereinafter, exemplary embodiments and examples of the present invention will be described in detail below with reference to the accompanying drawings, so that the present invention may be readily implemented by those skilled in the art

However, it is to be noted that the present invention is not limited to the exemplary embodiments and examples but can be embodied in various other ways. In drawings, parts irrelevant to the description are omitted for the simplicity of explanation, and like reference numerals denote like parts throughout the whole document.

Throughout the whole document, the terms “connected to” are “coupled to” that are used to designate a connection or coupling of one element to another element includes both a case in which the one element is directly connected or coupled to the other element and cases in which the element is electrically connected or coupled to the other element via still another element.

Throughout the whole document, the term “on” that is used to designate a position of one element with respect to another element includes both a case in which the one element is in contact with the other element and cases in which there are one or more other elements between the two elements.

Further, the terms “comprises,” “includes,” “comprising” and “including” used in the document are not intended to exclude one or more other components, steps, operations and/or existence or addition of elements in addition to the described components, steps, operations and/or elements unless context dictates otherwise.

The terms “about,” “approximately” and “substantially” are used to indicate meanings close to numerical values or ranges specified with an allowable error and intended to prevent precise or absolute numerical values disclosed for understanding of the present invention from being illegally or unfairly used by any unconscionable third parties. Throughout the whole document, the term “step of does not mean “step for.”

Throughout the whole document, the term “combination of included in Markush type descriptions refers to a mixture or combination of one or more components, steps, operations and/or elements selected from a group consisting of components, steps, operation and/or elements described in Markush type and thereby means that the present invention includes one or more components, steps, operations and/or elements selected from the Markush group.

The present invention relates to a separator for electrochemical devices including a porous substrate, and a coating layer of a thin film prepared by coating an inorganic oxide on the porous substrate.

The porous substrate is a polymer which is used as a separator for electrochemical devices and has a structure suitable for movement of ions. The porous substrate is not specifically limited as long as it includes a continuous porous structure with a high porosity suitable for movement of lithium ions between electrodes and relatively uniform pore size distribution.

The porous substrate may be a substrate made of any one of polymers which are typically used as materials of a separator for electrochemical devices and manufactured by an elongation process. More particularly, the porous substrate may include one or more selected from the group consisting of polyethylene (high-density polyethylene, low-density polyethylene, linear low density polyethylene, high molecular weight polyethylene, and the like), polypropylene terephthalate, polyethylene terephthalate, polybutylene terephthalate, polyester, polyacetal, polyamide, polycarbonate, polyimide, polyetheretherketone, polyethersulfone, polyphenylene oxide, polyphenylene sulfide, and polyethylene naphthalene.

Although a thickness of the porous substrate is not largely limited, a thickness may preferably be in the range of about 1 μm to about 100 μm and more preferably in the range of about 5 μm to about 30 μm. Further, pores may preferably have a size in the range of about 0.1 μm to about 1 μm and porosity in the range of from about 10% to about 80%.

It is preferable to use the porous substrate having a water contact angle in the range of about 10 degrees to about 120 degrees since interface adhesion between the porous substrate and an inorganic thin film can be increased.

The inorganic oxide is preferably an inorganic oxide having a high dielectric constant of about 5 or more and preferably about 10 or more, and a lithium ion transfer capacity. More preferably, the inorganic oxide may include, but is not limited to, one or more selected from the group consisting of BaTiO₃, Pb(Zr,Ti)O₃ (PZT), hafnia (HfO₂), SrTiO₃, CeO₂, MgO, NiO, CaO, ZnO, ZrO₂, Y₂O₃, Al₂O₃, TiO₂, and SiO₂. The inorganic oxide contributes to an increase in dissociation rate of electrolyte salt, such as lithium salt, in a liquid electrolyte, resulting in improvement of ionic conductivity of the electrolyte. The coating layer may be suitably formed of a thin film having a thickness in the range of preferably about 1 nm to about 500 nm, more preferably about 5 nm to about 300 nm, and still more preferably about 10 nm to about 150 nm If the coating layer has a thickness of less than about 1 nm, a thermal property of a separator cannot be maintained at a high temperature. If the coating layer has a thickness of more than about 500 nm, the thickness of the coating layer is increased and the coating layer serves as a resistance layer clogging pores of an existing polymer separator, and thus a performance of an electrochemical device may be deteriorated.

In particular, the coating layer formed by coating the porous substrate with an inorganic oxide may include all of a surface of the substrate and the insides of pores. The pores formed after coating may be in the range of about 10 nm to about 1 μm in size and porosity in the range of about 5% to about 75%.

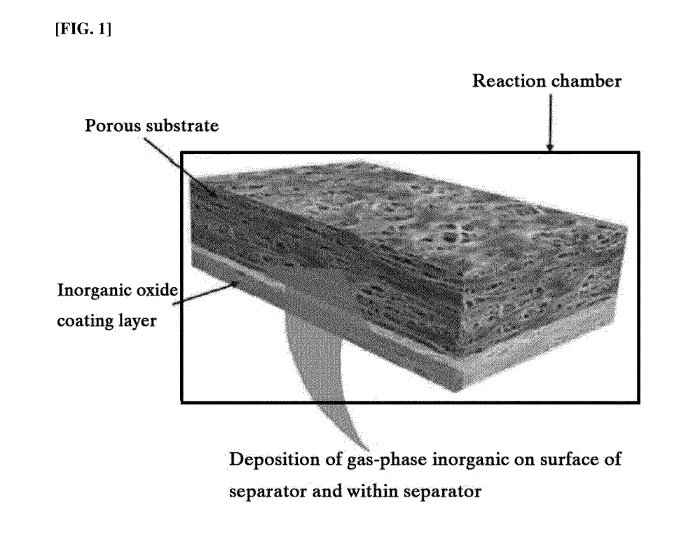

FIG. 1 is a schematic cross-sectional view of a separator including an inorganic oxide coating layer formed of a thin film on a porous substrate according to an exemplary embodiment of the present invention. In the separator of the present invention, one or both surfaces of a polymer porous substrate having multiple pores are coated thinly with an inorganic oxide.

The present invention also relates to a method of manufacturing a separator for electrochemical devices including manufacturing a thin-film coating layer coating a porous substrate with an inorganic oxide by deposition of an inorganic precursor on the porous substrate.

A method of coating the porous substrate with the inorganic oxide is capable of maintaining an excellent mechanical property of an existing polymer separator and also improving a thermal property thereof. Any method that is a deposition method capable of manufacturing a thin-film separator by coating an inorganic oxide coating layer is applicable. Preferably, the deposition method may include chemical vapor deposition (CVD), atomic layer deposition (ALD), chemical bath deposition (CBD) or thermal evaporation deposition. Further, in order to form the coating layer within pores of the porous substrate, a deposition method may be repeatedly performed.

Here, as an example method using chemical vapor deposition of the present invention, there is a method including introducing a gas-phase inorganic precursor through various paths into a reaction chamber where a substrate to be coated is placed, decomposing a compound produced by a deposition mechanism, and then forming an inorganic oxide thin film.

The inorganic precursor may include one or more selected from the group consisting of SiCl₄ (silicon tetrachloride), TEMASi (tetrakis-ethyl-methyl-amino-silicon), TiCl₄ (titanium chloride), TTIP (titanium-tetrakis-isopropoxide), TEMAT (tetrakis-ethyl-methyl), TDMAT (tetrakis-ethyl-methyl-amino-titanium), TDMAT (tetrakis-ethyl-methylamino-titanium), TDMAT (tetrakis-dimethyl-amino-titanium), TDEAT (tetrakisdiethyl-amino-titanium), TMA (tri-methyl-aluminum), MPTMA (methyl-pyrrolidine-tri-methyl-aluminum), EPPTEA (ethyl-pyridine-triethyl-aluminum), EPPDMAH (ethyl-pyridine-dimethyl-aluminum hydride), IPA (C₃H₇-O)₃Al), TEMAH (tetrakis-ethyl-methyl-amino-hafnium), TEMAZ (tetrakis-ethyl-methylamido-zirconium), TDMAH (tetrakis-dimethyl-amino-hafnium), TDMAZ (tetrakisdimethyl-amino-zirconium), TDEAH (tetrakis-diethyl-amino-hafnium), TDEAZ (tetrakis-diethyl-amino-zirconium), HTB (hafnium tetra-tert-butoxide), ZTB (zirconium tetra-tert-butoxide), HfCl₄ (hafnium chloride), Ba(C₅H₇O₂)₂, Sr(C₅H₇O₂)₂, Ba(C₁₁H₁₉O₂)₂, Sr(C₁₁H₁₉O₂)₂, Ba(C₅HF₆O₂)₂, Sr(C₁₀H₁₀F₇O₂)₂, Ba(C₁₀H₁₀F₇O₂)₂, Sr(C₁₀H₁₀F₇O₂)₂, Ba(C₁₁H₁₉O₂)—CH₃(OCH₂CH₂)₄OCH₃, Sr(C₁₁H₁₉O₂)₂—CH₃(OCH₂HC₂)₄OCH₃), Ti(OC₂H₅)₄, Ti(OC₃H₇)₄, Ti(OC₄H₉)₄, Ti(C₁₁H₁₉O₂)₂(OC₃H₇)₂, Ti(C₁₁H₁₉O₂)₂(O(CH₂)₂OCH₃)₂, Pb(C₅H₇O₂)₂, Pb(C₅HF₆O₂)₂, Pb(C₅H₄F₃O₂)₂, Pb(C₁₁H₁₉O₂)₂, Pb(C₁₁H₁₉O₂)₂, Pb(C₂H₅)₄, La(C₅H₇O₂)₃, La(C₅HF₆O₂)₃, La(C₅H₄F₃O₂)₃, La(C₁₁H₁₉O₂)₃, Zr(OC₄^{H}₉)₄, Zr(C₅^{HF}₆O₂)₄, Zr(C₅H₄F₃O₂)₄, Zr(C₁₁H₁₉O₂)₄, Zr(C₁₁H₁₉O₂)₂(OCH₃H₇)₂, TMSTEMAT (MeSiN═Ta(NEtMe)₃), TBITEMAT (Me₃CN═Ta(NEtMe)₃), TBTDET (Me₃CN═Ta(NEt₂)₃), PEMAT (Ta[N(CH₃)(C₂H₅)]₅), PDEAT (Ta[N(C₂H₅)₂]₅), PDMAT (Ta[N(CH₃)₂]₅), and TaF₅.

It is desirable to perform a plasma process on a surface of the porous substrate before coating and vary a water contact angle in the range of about 10 degrees to about 120 degrees. In order to vary the water contact angle, the porous substrate may be manufactured by forming a molded separator.

The separator according to the present invention is capable of maintaining an excellent mechanical property and ionic conductivity of an existing separator and also improving a thermal property, and can be high-density charged for high capacity.

Furthermore, the present invention provides an electrochemical device including a positive electrode, a negative electrode, the above-described separator, and an electrolyte.

The electrochemical device may include all devices that have electrochemical reactions and to be specific, includes all kinds of primary and secondary batteries, fuel cells, solar cells or capacitors. In particular, a lithium secondary battery among the secondary batteries is desirable and the lithium secondary battery may include, for example, a lithium metal secondary battery, a lithium ion secondary battery, a lithium polymer secondary battery or a lithium ion polymer secondary battery.

The electrochemical device can be manufactured by a typical method known in the art. By way of example, the electrochemical device may be manufactured by interleaving the above-described separator between the electrodes and then implanting an electrolyte.

The electrodes are not specifically limited, but a typical positive electrode active material which can be used for a positive electrode of a conventional electrochemical device may be used, and in particular, may include preferably a lithium adsorption material such as lithium manganese oxide, lithium cobalt oxide, lithium nickel oxide or a complex oxide formed of a combination thereof. Further, a typical negative electrode active material which can be used for a negative electrode of a conventional electrochemical device may be used, and in particular, may preferably include lithium metal, or a lithium adsorption material such as a lithium alloy and carbon, petroleum coke, active carbon, graphite or another carbon material. The above-described positive electrode active material is bonded to a positive current collector, that is, foil formed of aluminum, nickel, or a combination thereof and to a negative current collector, that is, foil formed of copper, gold, nickel or a copper alloy, or a combination thereof to constitute the both electrodes.

The electrolyte used in the present invention is a salt composed of A⁺B⁻. Herein, desirably, the salt composed of A⁺ including ions formed of alkali metallic positive ions such as Li⁺, Na⁺, and K⁺, and combinations thereof and B⁻ including ions formed of negative ions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻, and combinations thereof may be preferably dissolved or dissociated in an organic solvent formed of propylene carbonate (PC), ethylene carbonate (EC), diethyl carbonate (DEC), dimethyl carbonate (DMC), dipropyl carbonate (DPC), dimethylsulfoxide, acetonitrile, dimethoxyethane, diethoxyethane, tetrahydrofuran, N-methyl-2-pyrrolidone (NMP), ethylmethyl carbonate (EMC), gammabutyrolactone (GBL) or combinations thereof.

A process of implanting the electrolyte may be appropriately performed during a process of manufacturing a battery depending on a manufacturing process and a required property of a final product. That is, the process may be performed before assembly of a battery or during a final process of assembling a battery.

Hereinafter, the present invention will be described in more detail with reference to examples. However, the following Examples are only provided for illustration of the present invention, and the present invention is not limited to the following Examples.

### EXAMPLE 1

Manufacture of Separator

A flow molded separator was prepared through a melt extrusion process of a polyethylene (PE) polymer, and then a porous substrate having pores of about 1 μm in size and having a thickness of about 18 μm was manufactured through an elongation process by means of crystallization annealing. The porous substrate (porosity of 40%) was processed under 20 W oxygen plasma for 10 minutes so as to have a water contact angle of 30 degrees. The porous substrate was placed in a container containing silicon tetrachloride (SiCl₄) as a silicon precursor within a reaction chamber at 80° C. Thus, the porous substrate was exposed to moisture in the air and both surfaces thereof were coated with a SiO₂ film which is an inorganic oxide. At this time, the inorganic thin film was capable of being coated on a surface of the substrate and surface of a polymer constituting the inner pores. A cross-sectional thickness of the coating layer was adjusted to about 40 nm A separator manufactured as described above had pores of 100 nm in size and porosity of 38%.

Preparation of Positive Electrode

A lithium cobalt complex oxide of 92% by weight as a positive electrode active material, carbon black of 4% by weight as a conductor, and polyvinylidene fluoride (PVdF) of 4% by weight as a bonding agent were added into n-methyl-2-pyrrolidone (NMP) as a solvent to prepare a positive electrode mixture slurry. The positive electrode active material slurry was coated on an aluminum (Al) thin film of a positive current collector of 20 μm in thickness and dried so as to prepare a positive electrode. Then, the positive electrode was roll-pressed.

Preparation of Negative Electrode

Carbon powder of 96% by weight as a negative electrode active material, PVdF of 3% by weight as a bonding agent, and carbon black of 1% by weight as a conductor were added into NMP as a solvent to prepare a negative electrode mixture slurry. The negative electrode active material slurry was coated on a copper (Cu) thin film of a negative current collector of 10 μm in thickness and dried so as to prepare a negative electrode. Then, the negative electrode was roll-pressed.

Preparation of Battery

The positive electrode, negative electrode and separator prepared as described above were assembled by a stacking method, and an electrolyte [ethylene carbonate (EC)/ethylmethyl carbonate (EMC)/diethylene carbonate (DEC)=1/1/1 (volume ratio), 1 M of lithium hexafluorophosphate (LiPF₆)] was implanted into the assembled battery so as to prepare a lithium secondary battery.

### EXAMPLE 2

A molded separator was prepared by dissolving a polyvinylidene fluoride (PVdF) polymer in an acetone solvent and then performing a casting process, and then a porous substrate having a thickness of about 18 μm was manufactured. The porous substrate (porosity of 35%) was processed under 20 W oxygen plasma for 10 minutes so as to have a water contact angle of 40 degrees. The porous substrate was placed in a container containing silicon tetrachloride (SiCl₄) as a silicon precursor within a reaction chamber at 80° C. Thus, the porous substrate was exposed to moisture in the air and both surfaces thereof were coated with a SiO₂ film which is an inorganic oxide. At this time, the inorganic thin film was capable of being coated on a surface of the substrate and surface of a polymer constituting the inner pores. A cross-sectional thickness of the coating layer was adjusted to about 40 nm A separator manufactured as described above had a pore of 800 nm in size and porosity of 34%.

A process of preparing a battery using the separator was performed in the same manner as described in Example 1.

### EXAMPLE 3

The separator manufactured in Example 1 was coated with EPPTEA by means of atomic layer deposition, so that an inorganic oxide Al₂O₃ was coated on a surface of the separator and inner pores to prepare a new separator (pore size: 300 nm to 700 nm, porosity: 42%, thickness of coating layer: 20 nm).

A process of preparing a battery using the separator was performed in the same manner as described in Example 1.

### COMPARATIVE EXAMPLE 1

A battery was prepared in the same manner as described in Example 1 except that a separator including a PE porous substrate which was not coated with an inorganic layer was used.

### COMPARATIVE EXAMPLE 2

A battery was prepared in the same manner as described in Example 1 except that a new separator prepared by coating both surfaces of a PE porous substrate with Al₂O₃ of 400 nm in size to be a thickness of 5 μm, respectively, was used.

### COMPARATIVE EXAMPLE 3

Coating of Al₂O₃ on a surface of a PE porous substrate by means of a sol-gel method was attempted, but no coating layer was formed. Therefore, a comparative experiment could not proceed.

### EXPERIMENTAL EXAMPLE 1

### Confirmation of Formation of Coating Layer on Separator

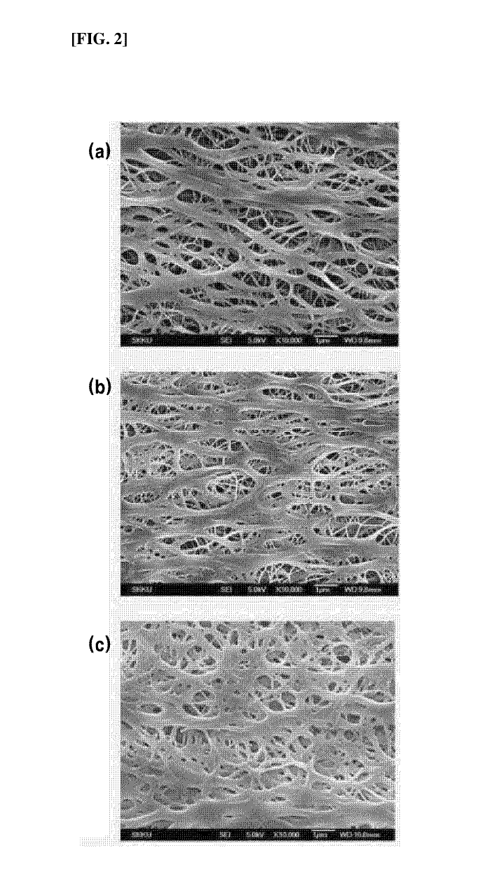

FIG. 2 shows scanning electron microscope (SEM) images observing a cross section of a separator and a cross section of a PE porous substrate prepared according to Example 1.

Referring to FIG. 2, it could be seen that in a separator of the present invention, an inorganic coating layer of about 40 nm in thickness was formed (FIG. 2(b)) on a surface of a PE porous substrate (FIG. 2(a)) and pores of an existing separator were not clogged with an inorganic oxide, and thus an existing microporous structure could be maintained and there was no problem in movement of ions. FIG. 2(c) shows a SEM image of a separator (thickness: 20 nm) prepared by means of atomic layer deposition in Example 3.

### EXPERIMENTAL EXAMPLE 2

### Evaluation of Thermal Contraction Rate of Separator

The separators of Examples 1 to 3 and Comparative Examples 1 and 2 were stored at 150° C. for 1 hour, and then thermal contraction rates thereof were evaluated. The results are listed in Table 1.

As a result of the evaluation, the typical polyolefin-based PE separator (Comparative Example 1) exhibited a thermal contraction rate of 90% or more, whereas the separators (Examples 1, 2, and 3) each including an inorganic oxide thin film formed within a porous polymer substrate according to the present invention exhibited a thermal contraction rate of less than 5%. Although the separator of Comparative Example 2 including a porous substrate of which surfaces were coated with inorganic nanoparticles exhibited a thermal contraction rate of about 10%, each surface was coated with 5 μm of inorganic nanoparticles for a total of 10 μm. Thus, there was a problem in that a thickness of the separator was increased, resulting in a decrease in capacity of a battery having a certain volume.

TABLE 1

| | Exam- | Exam- | Exam- | Comparative | Comparative |
|---|---|---|---|---|---|
| Item | ple 1 | ple 2 | ple 3 | Example 1 | Example 2 |
| Thermal | <5% | <5% | <5% | >90% | <10% |
| contraction | | | | | |
| rate | | | | | |

### EXPERIMENTAL EXAMPLE 3

### Evaluation of Mechanical Property of Separator

Tensile strengths of the separators of Examples 1 to 3 and Comparative Examples 1 and 2 were evaluated by a typical measurement method, and the results are listed in Table 2.

As a result of the evaluation, the typical polyolefin-based PE separator (Comparative Example 1) exhibited a tensile strength of about 80 MPa, whereas the separator (Example 1) including an inorganic oxide thin film formed on a porous polymer substrate by means of chemical vapor deposition according to the present invention exhibited a tensile strength of about 120 MPa or more.

TABLE 2

| | | | | Comparative | Comparative |
|---|---|---|---|---|---|
| Item | Example 1 | Example 2 | Example 3 | Example 1 | Example 2 |
| Tensile | 120 MPa | 119 MPa | 121 MPa | 80 MPa | 50 MPa |
| strength | | | | | |

### EXPERIMENTAL EXAMPLE 4

### Evaluation of Performance of Battery

The batteries of Examples 1 to 3 and Comparative Examples 1 and 2 each having a positive electrode capacity of 4 mAh and a negative electrode capacity of 4 mAh were charged at 0.2 C and then 0.2 C discharge capacities thereof were measured. The results are listed in Table 3.

Referring to Table 3, it could be seen that discharge capacity of the separator according to Example 1 of the present invention increased as compared with Comparative Example 1.

TABLE 3

| | Exam- | Exam- | Exam- | Comparative | Comparative |
|---|---|---|---|---|---|
| Item | ple 1 | ple 2 | ple 3 | Example 1 | Example 2 |
| Discharge | 3.6 | 3.6 | 3.6 | 3.4 | 3.2 |
| capacity | | | | | |

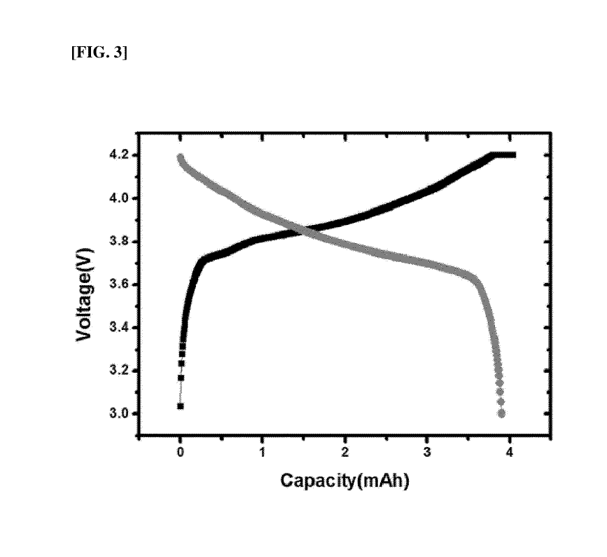

FIG. 3 is a graph illustrating charge/discharge operations of a battery according to Example 1, and the battery was charged at 0.2 C and then a 0.2 C discharge capacity thereof was measured.

The separator according to the present invention has an improved thermal property at a high temperature, so that it is possible to assemble a battery capable of preventing internal short circuit with high stability.

Further, according to the method of manufacturing a separator according to the present invention, a thin inorganic separator which can be high-density charged for high capacity can be independently manufactured and a conventionally used separator can be improved so as to obtain an appropriate mechanical property and excellent ionic conductivity with a continuous porous structure suitable for movement of ions.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A separator for electrochemical devices, comprising:
a porous substrate; and
a thin film coating layer prepared by coating an inorganic oxide on the porous substrate.

2. The separator of claim 1, wherein the porous substrate has pores in a range of 0.1 μm to 1 μm in size.

3. The separator of claim 1, wherein the porous substrate has porosity in a range of 10% to 80%.

4. The separator of claim 1, wherein the porous substrate includes one or more selected from the group consisting of polyethylene, polypropylene terephthalate, polyethylene terephthalate, polybutylene terephthalate, polyester, polyacetal, polyamide, polycarbonate, polyimide, polyetheretherketone, polyethersulfone, polyphenylene oxide, polyphenylene sulfide, and polyethylene naphthalene.

5. The separator of claim 1, wherein the porous substrate has a water contact angle in a range of 10 degrees to 120 degrees.

6. The separator of claim 1, wherein the inorganic oxide includes one or more selected from the group consisting of BaTiO₃, Pb(Zr,Ti)O₃(PZT), hafnia (HfO₂), SrTiO₃, CeO₂, MgO, NiO, CaO, ZnO, ZrO₂, Y₂O₃, Al₂O₃, TiO₂, and SiO₂.

7. The separator of claim 1, wherein the coating layer has a thickness in a range of 1 nm to 500 nm.

8. The separator of claim 1, wherein pores are in a range of 10 nm to 1 μm in size.

9. The separator of claim 1, wherein porosity is in a range of 5% to 75%.

10. The separator of claim 1, wherein the coating layer includes a surface of the porous substrate and the insides of pores.

11. A method of manufacturing a separator for electrochemical devices, the method comprising:
preparing a thin-film coating layer by coating an inorganic oxide on a porous substrate through deposition of an inorganic precursor on the porous substrate.

12. The method of claim 11, wherein the inorganic precursor includes one or more selected from the group consisting of SiCl₄ (silicon tetrachloride), TEMASi (tetrakis-ethyl-methyl-amino-silicon), TiCl₄ (titanium chloride), TTIP (titanium-tetrakis-isopropoxide), TEMAT (tetrakis-ethyl-methyl), TDMAT (tetrakis-ethyl-methyl-amino-titanium), TDMAT (tetrakis-ethyl-methylamino-titanium), TDMAT (tetrakis-dimethyl-amino-titanium), TDEAT (tetrakisdiethyl-amino-titanium), TMA (tri-methyl-aluminum), MPTMA (methyl-pyrrolidine-tri-methyl-aluminum), EPPTEA (ethyl-pyridine-triethyl-aluminum), EPPDMAH (ethyl-pyridine-dimethyl-aluminum hydride), IPA (C₃H₇-O)₃Al), TEMAH (tetrakis-ethyl-methyl-amino-hafnium), TEMAZ (tetrakis-ethyl-methylamido-zirconium), TDMAH (tetrakis-dimethyl-amino-hafnium), TDMAZ (tetrakisdimethyl-amino-zirconium), TDEAH (tetrakis-diethyl-amino-hafnium), TDEAZ (tetrakis-diethyl-amino-zirconium), HTB (hafnium tetra-tert-butoxide), ZTB (zirconium tetra-tert-butoxide), HfCl₄ (hafnium chloride), Ba(C₅H₇O₂)₂, Sr(C₅H₇O₂)₂, Ba(C₁₁H₁₉O₂)₂, Sr(C₁₁H₁₉O₂)₂, Ba(C₅HF₆O₂)₂, Sr(C₁₀H₁₀F₇O₂)₂, Ba(C₁₀H₁₀F₇O₂)₂, Sr(C₁₀H₁₀F₇O₂)₂, Ba(C₁₁H₁₉O₂)—CH₃(OCH₂CH₂)₄OCH₃, Sr(C₁₁H₁₉O₂)₂—CH₃(OCH₂HC₂)₄OCH₃), Ti(OC₂H₅)₄, Ti(OC₃H₇)₄, Ti(OC₄H₉)₄, Ti(C₁₁H₁₉O₂)₂(OC₃H₇)₂, Ti(C₁₁H₁₉O₂)₂(O(CH₂)₂OCH₃)₂, Pb(C₅H₇O₂)₂, Pb(C₅HF₆O₂)₂, Pb(C₅H₄F₃O₂)₂, Pb(C₁₁H₁₉O₂)₂, Pb(C₁₁H₁₉O₂)₂, Pb(C₂H₅)₄, La(C₅H₇O₂)₃, La(C₅HF₆O₂)₃, La(C₅H₄F₃O₂)₃, La(C₁₁H₁₉O₂)₃, Zr(OC₄^{H}₉)₄, Zr(C₅^{HF}₆O₂)₄, Zr(C₅H₄F₃O₂)₄, Zr(C₁₁H₁₉O₂)₄, Zr(C₁₁H₁₉O₂)₂(OCH₃H₇)₂, TMSTEMAT(MeSiN═Ta(NEtMe)₃), TBITEMAT (Me₃CN═Ta(NEtMe)₃), TBTDET(Me₃CN═Ta(NEt₂)₃), PEMAT (Ta[N(CH₃)(C₂H₅)]₅), PDEAT (Ta[N(C₂H₅)₂]₅), PDMAT (Ta[N(CH₃)₂]₅), and TaF₅.

13. The method of claim 11, wherein the deposition is performed using chemical vapor deposition (CVD), atomic layer deposition (ALD), chemical bath deposition (CBD) or thermal evaporation deposition.

14. The method of claim 11, wherein the porous substrate is manufactured through an elongation process after a molded separator is prepared.

15. A separator for electrochemical devices manufactured by the method of claim 11.

16. An electrochemical device comprising:
a positive electrode;
a negative electrode;
a separator; and
an electrolyte,
wherein the separator is the separator of claim 1.

17. The electrochemical device of claim 16, wherein the electrochemical device is a lithium secondary battery.
